(19) United States
(12) Patent Application Publication
(10) Pub. No.: US 2012/0175389 A1
(43) Pub. Date: Jul. 12, 2012

(54) GAME CARRIER

(75) Inventor: Christopher M. NOOK, Russell, OH (US)

(73) Assignee: HUNTDUCKS, LLC, Russell, OH (US)

(21) Appl. No.: 13/347,247

(22) Filed: Jan. 10, 2012

Related U.S. Application Data
(60) Provisional application No. 61/431,627, filed on Jan. 11, 2011.

(51) Int. Cl. A01K 65/00

(52) U.S. Cl. 224/103

(57) ABSTRACT

A game carrier to aid a hunter in securing and transporting game. The carrier includes a housing and a gate. The housing has a first arm portion, a second arm portion parallel to and spaced a width apart from the first arm portion, a top arcuate portion connecting the first arm portion to the second arm portion, and a bottom arcuate portion disposed opposite the top arcuate portion and connecting the first arm portion to the second arm portion. The first arm portion defines an opening along its length. The gate is hinged on the first arm portion at a first end of the opening and moveable between a closed position and an open position. A length of the opening and the width between the first and second arm portions each accommodate the neck thickness of an article of game.

### CROSS-REFERENCE TO RELATED APPLICATION

This application claims the benefit of U.S. Provisional Patent Application Ser. No. 61/431,627, entitled SMALL GAME CARRIER and filed Jan. 11, 2011, the entire disclosure of which is incorporated herein by reference, to the extent that it is not conflicting with the present application.

### BACKGROUND

Hunting is a popular and enjoyable activity for many people. Whether hunting is undertaken for sport, recreation, or a source of food, successful hunters face the task of transporting game that has been shot, trapped or otherwise killed. A hunter may need to carry game from a hunting location back to an origination site of the hunt, or carry game so that the hunt may continue. Often the hunting location can be miles from the origination site. Because game often is transported on foot, a hunter is sometimes limited in the amount of game that can be harvested. Similarly, the length of the hunt may be undesirably shortened.

A carrier may be used to transport game. Exemplary game carriers for large game, e.g., deer, can be pushed or pulled by the hunter. For small game, e.g., birds, some carriers are arranged to be worn by the hunter, for example, around the waist or attached to an article of clothing. Conventional carriers have structural limitations that may adversely effect their performance characteristics, such as for example, carrying capacity, carrier flexibility, ease of loading and unloading game, and features for securing game.

### SUMMARY OF THE INVENTION

In an embodiment of the invention, a game carrier includes features to aid a hunter in transporting game. The carrier includes a housing and a gate. The housing has a first arm portion, a second arm portion parallel to and spaced a width apart from the first arm portion, a top arcuate portion connecting the first arm portion to the second arm portion, and a bottom arcuate portion disposed opposite the top arcuate portion and connecting the first arm portion to the second arm portion. The first arm portion defines an opening along its length. The gate is hinged on the first arm portion at a first end of the opening and moveable between a closed position and an open position. A length of the opening and the width between the first and second arm portions each accommodate the neck thickness of an article of game.

The user may manipulate the gate to load and unload game, as well as to attach the carrier to a secured location, such as for example, a D-ring of a shoulder strap. A user may attach multiply carriers to a shoulder strap to increase capacity.

### BRIEF DESCRIPTION OF THE DRAWINGS

Features and advantages of the invention will become apparent from the following detailed description made with reference to the accompanying drawings.

FIG. 1 is a front view of a game carrier, showing a gate closed and, in phantom, several game in storage within the carrier;

FIG. 2 is a front view of the game carrier of FIG. 1, shown with the gate removed;

FIG. 3 is an enlarged front view of a portion of FIG. 2, showing detail of the game carrier in the area adjacent the gate in FIG. 2;

FIG. 4 is an enlarged left side view of the gate of FIG. 1;

FIG. 5 is a perspective view of a game carrier attached to a shoulder strap; and

FIG. 6 is another perspective view of a game carrier attached to a shoulder strap.

### DETAILED DESCRIPTION OF THE INVENTION

The Detailed Description of the Invention merely describes preferred embodiments of the invention and is not intended to limit the scope of the invention in any way. Indeed, the invention as described by the claims is broader than and unlimited by the preferred embodiments, and the terms used have their full ordinary meaning.

According to an inventive aspect of the present application, a game carrier may be provided for transporting one or more animals. The game carrier is adapted for carrying small game, such as for example, ducks, pheasant, quail, other types of birds, or other relatively smaller animals. The game carrier is shaped to retain game within the carrier by sliding an animal's neck through a gate, and downward between a pair of carrying arms. The width between the pair of carrying arms accommodates the width of the animal's neck, but is smaller than the width of the animal's skull or torso. The width between the carrying arms can be adjusted in various embodiments of the design to accommodate small game of various larger sizes, such as for example, fox, otters, or muskrat.

The game carrier is adapted to be used as part of a game transport system. In such a system, the hunter may attach multiple devices to a shoulder strap to permit the hunter to carry more game as needed, and different type of game with a plurality of carriers, each carrier having a different width between the pair of carrying arms.

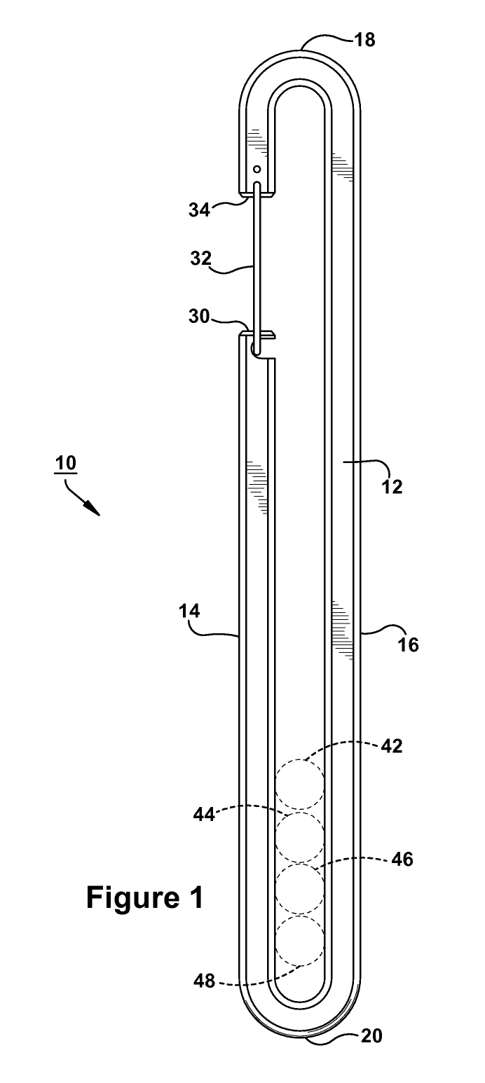

Referring now to the drawings, FIG. 1 is a front view of a game carrier 10. The illustrated game carrier 10 is formed in part by a rod 12, or housing, having a race-track or oval shape. The rod includes an elongated and parallel set of arms, i.e., a first arm 14 and a second arm 16. The arms 14, 16 are separated at either end by a top bend portion 18 and a bottom bend portion 20. Each bend portion 18, 20 is a semi-circle shape and has a radius R₁ as shown is 180 degrees, although other configurations are possible in the practice of the invention. The rod 12 may be a single piece, or formed of multiple pieces fixed together into the illustrated shape or another shape. In one embodiment, the rod is constructed of a relatively stiff and inexpensive material, such as for example, hard anodized steel, but can also be constructed of other suitable materials. Further, it should be apparent that the dimensions of the game carrier 10 can vary in the practice of the invention.

Adjacent the upper bend portion 18, an opening 30 is defined in the first arm portion 14. The opening 30 is provided for a hunter to move game into and out of the carrier 10. A gate 32 is hinged at one end 34 of the opening for user movement between a closed position, as shown in FIG. 1, and an open position, with the gate rotated inward toward the second rail 16. The user manipulates the gate 32 to load and unload game within the.

To load an animal, a hunter must first swing the gate 32 counter-clockwise, or inward, to an open position. When grasping the animal, a hunter may slide the animal's neck through the opening 30 toward the second arm portion 16, into the space between the first and second arms portions 14, 16, and then in the direction of the bottom bend portion 20. In one embodiment, the gate 32 will swing open upon pressure from the animal's neck, and swing closed under the force of gravity after the animal has been moved toward the bottom bend portion 20. The hunter may rely on gravity to position the animal, or may manually place or force the animal into a desired stored position.

The game carrier is designed to carry multiple game is an arrangement that is easy to load and unload. Within the game carrier 10 and adjacent the lower bend portion 20, several individual game 42, 44, 46, 48 are shown in phantom in a stored position. In the front view of FIG. 1, the cross-section of the animal's neck is shown. Exemplary game are illustrated in phantom as birds in the perspective view of FIG. 1 in U.S. Pat. No. D647,164, issued Oct. 11, 2011, which is hereby incorporated by reference. The game 42, 44, 46, 48 are illustrated in cross section at the neck, such that the skull is on one side of the carrier and the body is on the opposing side. In other words, the size of the animal's neck must be small enough to fit between the first and second arm portions 14, 16, but the size of the animal's skull and body must each be too large to fit between the first and second arm portions 14, 16. As such, an animal of pre-determined size will hang by gravity in the stored position shown in FIG. 1, and no other binding, anchoring or attaching of the game is required.

The game carrier also offers inventory advantages to the hunter. Specifically, an inventory of the hunt can also be taken in the arrangement of FIG. 1. An exemplary inventory arrangement would include a plurality of birds each having identifying labels on the same body part, such as for example, neck or feet. Thus, inventory can be taken or data recorded by a scan of only one side of the game carrier 10.

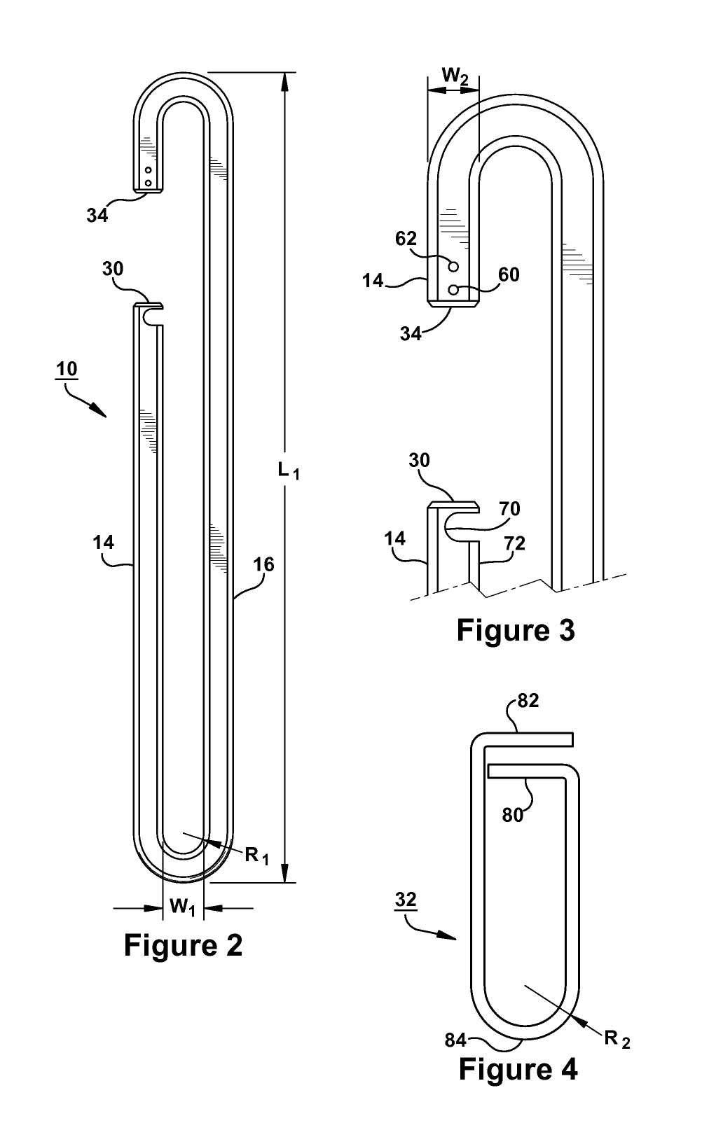

The type of game that can be carried, and the amount of game that can be carried, can vary with the practice of this invention. As is apparent from FIG. 2, the type or types of game that can be stored is at least partially dependent upon the width W₁ between the first arm portion 14 and the second arm portion 26. The number of animals that can be stored in a single game carrier 10 is at least partially dependent upon the length L₁ of the game carrier. Further, the hunter can increase the number of animals that can be stored by use of a carrier system, which will be discussed later in more detail.

The game carrier 10 is shown in FIG. 2 with the gate 32 removed. As such, the rod 12 alone is illustrated. Additional structural detail of the rod 12 is shown in FIG. 3. Specifically, detail in the area adjacent the gate 32 as designated by in the enlarged view of FIG. 2. Mounting structure is included in the first arm portion 14 to accommodate the gate 32. The hinged end of the gate 32 is mounted to the first arm portion 14 at a location on one side of the opening 30. As shown, the gate 32 is mountable to two apertures 60, 62 at locations above the opening 30. The apertures 60, 62 are sized to accept mounting pins 80, 82, respectively, of the gate 32. The gate includes a distal end 84 formed a radius R₂ of a bottom portion.

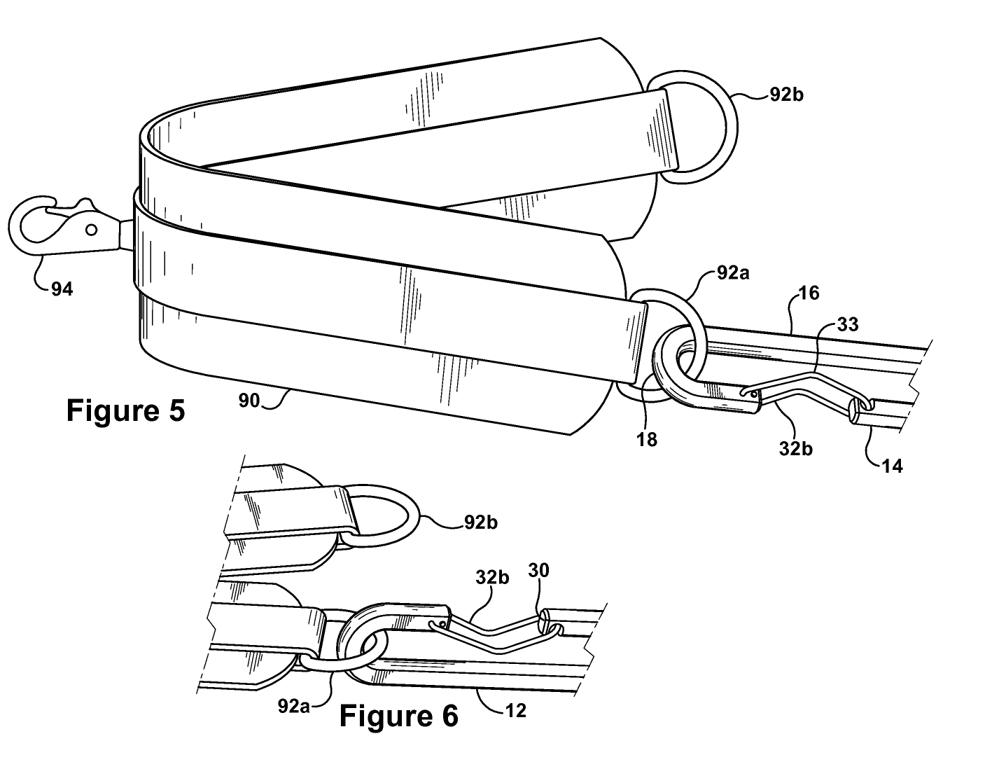

The gate 32 is mounted to swing as a hinge between an open position and a closed position. FIG. 4 is an enlarger left side view of the storage gate of FIG. 1. In the closed position, the distal end 84 of the gate 32 rests within a cavity 70 on the inside surface 72 of the first rod portion 14. Because the apertures 60, 62 are disposed on a longitudinal axis on the first rod portion, the distal end 84 can swing well within the cavity 70, as shown in FIG. 1. The concave shape of the cavity 70 offers no resistance to the opening of the gate 32 in the counter-clockwise direction. It should be apparent that the structure of the gate 32 may vary in the practice of this invention (e.g., see FIGS. 5 and 6). Other mounting arrangements are possible for the gate 32 in the practice of this invention. For example, the top lip of the cavity 70 may include structure to resist opening of the gate 32 as an added locking feature. It should also be apparent that the shape of the cavity 70 may vary in the practice of this invention.

A hunter using the game carrier 10 has several options available for personal storage and transport of the actual device. The game carrier 10 is adapted for ease of storage at a securing point, such as for example, an article of clothing worn by the hunter. In an embodiment illustrated in FIG. 5, the game carrier 10 is attached to a shoulder strap 90 arranged to be worn by the hunter. The shoulder strap 90 may have one or more securing locations, such as for example, a D-ring. More specifically, a D-ring may be located at opposing ends of the shoulder strap 90, such as for example, D-rings 92a, 92b. The game carrier 10 can be easily attached or removed from a D-ring by manipulation of the gate between open and closed positions. A hook 94 is fixed to the shoulder strap 90 to permit anchoring to another article of clothing worn by the hunter, such as for example, a hunting vest or jacket. A perspective view of the game carrier 10 attached to the D-ring 92a is shown in FIG. 6, which illustrates an alternative embodiment of a gate 32b. The gate has a center bend 33 extending toward the second rail 16.

The game carrier is designed for flexibility of use by the hunter. For example, a hunter may rely upon a system of carriers to increase the capacity of game that can be transported. In one embodiment, a hunter may attached two or more carriers to a D-ring of a shoulder strap. Alternatively, a hunter may attach additional D-rings to a shoulder strap to increase anchoring locations for game carriers. Further, a hunter may attach two or more shoulder straps to another article of clothing worn by the hunter, such as for example, a hunting vest or jacket.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A carrier for transporting one or more articles of game, the carrier comprising:
a housing having a first arm portion, a second arm portion parallel to and spaced a width apart from the first arm portion, a top arcuate portion connecting an end of the first arm portion and an end of the second arm portion, and a bottom arcuate portion disposed opposite the top arcuate portion and connecting an other end of the first arm portion and an other end of the second arm portion, the first arm portion defining an opening along its length; and
a gate hinged on the first arm portion at a first end of the opening and moveable between a closed position and an open position;
wherein a length of said opening and the width between said first arm portion and said second arm portion each accommodate the neck thickness of an article of game.

2. The carrier of claim 1 wherein said housing is formed from a single metal rod.

3. The carrier of claim 1 wherein said housing has an elongated oval shape.

4. The carrier of claim 1 wherein said first arm portion, said second arm portion, said top arcuate portion and said bottom arcuate portion are positioned within a common plane.

5. The carrier of claim 1 wherein said width between said first arm portion and said second arm portion is smaller than a skull thickness of an article of game.

6. The carrier of claim 1 wherein said width between said first arm portion and said second arm portion is smaller than a torso thickness of an article of game.

7. The carrier of claim 1 wherein an inside surface of said first arm portion defines a concave cavity for engagement with said gate in said closed position.

8. The carrier of claim 1 wherein said gate is v-shaped with a center point extending between said first arm portion and said second arm portion.

9. The carrier of claim 1 wherein said top arcuate portion and said bottom arcuate portion are semi-circle shaped.

10. A carrier for securing and transporting one or more articles of game, the carrier comprising:
a elongated-oval shaped frame having a first rail, a second rail parallel to and spaced a width apart from the first arm rail, the first rail defining an opening along its length; and
a gate hinged on the first rail at a first end of the opening and rotateable inward from a closed position to an open position;
wherein a length of said opening and the width between said first rail and said second rail each accommodate the neck thickness of an article of game, and said width between said first rail and said second rail is smaller than a skull thickness of an article of game.

11. The carrier of claim 10 wherein said frame has a top arcuate portion and a bottom arcuate portion, wherein said top arcuate portion and said bottom arcuate portion are semi-circle shaped.

12. The carrier of claim 10 wherein said gate is v-shaped with a center point extending inward between said first arm portion and said second arm portion.

13. The carrier of claim 10 wherein said width between said first rail and said second rail is smaller than a torso thickness of an article of game.
